(19) United States
(12) Patent Application Publication
(10) Pub. No.: US 2026/0220650 A1
(43) Pub. Date: Jul. 30, 2026

(54) MANAGEMENT SYSTEM FOR CUSTOMER SUPPORT SERVICES THAT UTILIZES AUTOCOMPLETE DATA STRUCTURES FOR DIFFERENT PROPERTIES

(71) Applicant: Toshiba Tec Kabushiki Kaisha, Tokyo (JP)

(72) Inventor: Marianne KODIMER, Huntington Beach, CA (US)

(21) Appl. No.: 19/040,299

(22) Filed: Jan. 29, 2025

(51) Int. Cl. G06Q 30/016; G06F 16/338

(52) U.S. Cl. CPC G06Q 30/016; G06F 16/338

(57) ABSTRACT

A management computer is configured to manage customer support services for hardware and software solutions, by performing the steps of: selecting, based on text received from a technician computer, a first autocomplete data structure from a plurality of autocomplete data structures; traversing nodes of the first autocomplete data structure to identify a plurality of matching identifiers (IDs) that each includes the text; transmitting user interface (UI) data to the technician computer to display each of the matching IDs, and then receiving information from the technician computer identifying a selection of one of the matching IDs; transmitting UI data to the technician computer to display management service options for hardware or software solutions associated with the selected ID, and then receiving a request from the technician computer to perform a customer support service for a hardware or software solution associated with the selected ID; and performing the customer support service.

### FIELD

Embodiments to be described herein generally relate to a management computer configured to carry out steps for managing customer support services, a method comprising such steps, and a non-transitory computer-readable medium comprising instructions that cause a management computer to carry out such steps.

### BACKGROUND

Customer support services allow for managing needs of customers of a variety of solutions, including hardware solutions such as multi-function printers (MFPs) and software solutions such as enterprise resource planning systems. Today, customer support services are often managed remotely by customer support technicians. Customer support technicians are able to perform tasks such as monitoring the performance of hardware and software solutions and troubleshoot issues with such performance. There is a desire to provide a more efficient management system for such customer support services.

### BRIEF DESCRIPTION OF THE DRAWINGS

FIG. 1 is a block diagram of a computer system in which embodiments may be implemented.

FIG. 2A is a block diagram of a prefix tree that may be used for autocompleting names associated with solutions, according to some embodiments.

FIG. 2B is a block diagram of a prefix tree that may be used for autocompleting numbers associated with solutions, according to some embodiments.

FIG. 3 is a flow diagram of a method that may be performed by a management computer and a technician computer to manage customer support services for solutions, according to some embodiments.

### DETAILED DESCRIPTION

One or more embodiments provide a management computer including a processor and memory, wherein the processor executes instructions stored in the memory to manage customer support services for hardware and software solutions. The management computer performs the steps of: selecting, based on text received from a technician computer, a first autocomplete data structure from a plurality of autocomplete data structures; traversing nodes of the first autocomplete data structure based on the text to identify a plurality of matching identifiers (IDs) that each includes the text; transmitting user interface (UI) data to the technician computer to display each of the matching IDs as autocomplete options, and then receiving information from the technician computer identifying a selection of one of the matching IDs; transmitting UI data to the technician computer to display management service options for hardware or software solutions associated with the selected ID, and then receiving a request from the technician computer to perform a customer support service for at least one hardware or software solution associated with the selected ID; and performing the customer support service for the at least one hardware or software solution.

According to some embodiments, the management computer enables customer support technicians, referred to herein simply as “technicians,” to identify hardware and software solutions at multiple levels of granularity. Such hardware and software solutions are sometimes referred to collectively herein as “solutions.” For example, the levels of granularity supported by some embodiments may include “customers” (end users) of solutions, “dealers” who act as intermediaries to provide (e.g., sell, lease, license, etc.) the solutions to the customers, and “geographic regions” (e.g., “countries”) at which customers and dealers are based. Such varying levels of granularity allow technicians to provide customer support services that are scalable, e.g., with increasing numbers of customers and dealers supported by technicians.

Furthermore, according to embodiments, the management computer enables technicians to easily specify identifiers (IDs), e.g., of customers, dealers, and geographic regions, using a plurality of different properties. For example, such properties may include names and numbers, and each name may correspond to a different number. For example, each customer may be associated with a customer name and a corresponding customer number. Similarly, each dealer may be associated with a dealer name and a corresponding dealer number, and each geographic region may be associated with a geographic region name (e.g., country name) and a corresponding geographic region number (e.g., country number).

According to embodiments, as a technician begins entering an ID, the management computer determines which property the technician is entering, e.g., a name or a number. The management computer then retrieves a corresponding autocomplete data structure such as a prefix tree for identifying various autocomplete options. For example, if the technician begins entering a name, the management computer retrieves an autocomplete data structure that stores strings representing, e.g., customer names, dealer names, and geographic region names. As another example, if the technician begins entering a number, the management computer retrieves an autocomplete data structure that stores strings representing, e.g., customer numbers, dealer numbers, and geographic region numbers.

The management computer then traverses the retrieved autocomplete data structure to identify autocomplete options for the technician to select from. The technician is thus able to locate solutions and provide customer support services based on a variety of different properties. Embodiments thus provide flexibility for technicians, e.g., when they only know one property (e.g., name or number) for identifying, e.g., a customer, dealer, or geographic region. Hereinafter, embodiments will be described with reference to the drawings. In the drawings, the same reference symbols denote the same or similar portions.

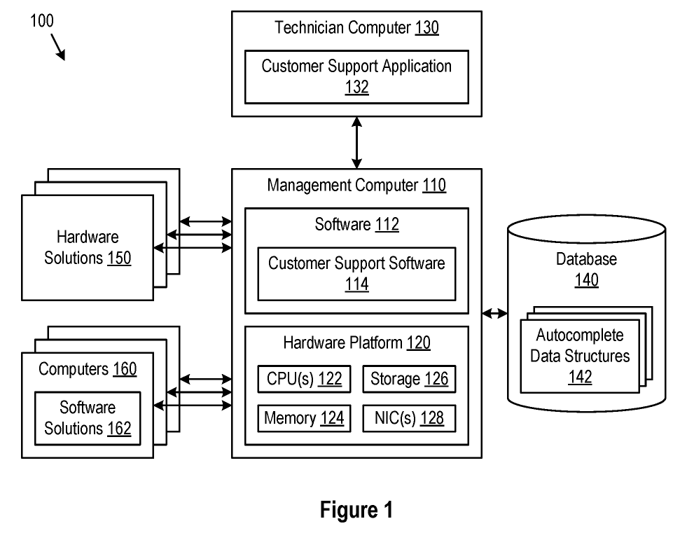

FIG. 1 is a block diagram of a computer system 100 in which embodiments may be implemented. Computer system 100 includes a management computer 110, a technician computer 130, a database 140, hardware solutions 150, and computers 160. Technician computer 130 is used by a technician to provide customer support services that are managed by management computer 110. Such customer support services are provided for hardware solutions 150 and for software solutions 162 executing on computers 160.

Management computer 110 may be, e.g. a server computer. For example, management computer 110 may be deployed in a private data center controlled by an organization that provides customer support services for solutions. As another example, management computer 110 may be deployed in a public data center at which infrastructure is provisioned for many users and organizations. Management computer 110 is constructed on a hardware platform 120 such as an x86 architecture platform.

Hardware platform 120 includes components of a computer, such as one or more central processing units (CPUs) 122, memory 124 such as random-access memory (RAM), local storage 126 such as one or more magnetic drives or solid-state drives (SSDs), and one or more network interface controllers (NICs) 128. CPU(s) 122 are configured to execute instructions such as executable instructions that perform one or more operations described herein, which may be stored in memory 124. NIC(s) 128 enable management computer 110 to communicate with other devices over a network such as the Internet.

Hardware platform 120 supports software 112 including customer support software 114. Customer support software 114 is programmed to manage customer support services for hardware solutions 150 and software solutions 162. For example, customer support software 114 may be programmed to communicate with hardware solutions 150 to collect health or performance information thereof. Similarly, customer support software 114 may be programmed to communicate with computers 160 to collect health or performance information of software solutions 162. Examples of health and performance information include, e.g., system uptime metrics, error logs, hardware resource utilization metrics, etc.

Database 140 is a structured collection of data that is managed by customer support software 114. For example, database 140 may be stored externally from management computer 110, e.g., on one or more magnetic drives or SSDs of a storage array. As another example, although illustrated as being external to management computer 110, database 140 may be stored in storage 126 of hardware platform 120. Customer support software 114 may persist autocomplete data structures 142 in database 140.

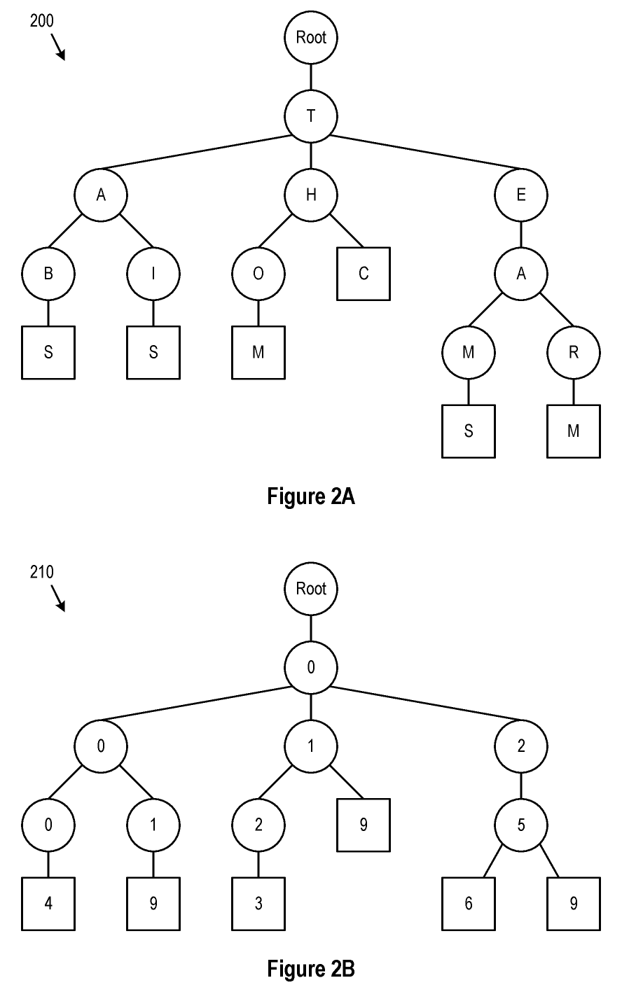

Autocomplete data structures 142 are data structures that store information that is used for an autocomplete feature of customer support software 114. The autocomplete feature includes suggesting possible matches to entered text, e.g., matches to sequences of numbers or letters that a technician has typed. Examples of autocomplete data structures 142 include, e.g., prefix trees, hash maps, and binary search trees. Examples of autocomplete data structures 142 implemented as prefix trees are discussed below in conjunction with FIGS. 2A and 2B. Management computer 110 may populate each of autocomplete data structures 142 with strings based on a different property.

For example, one property may be “name,” which is an ID that may include, e.g., letters or a combination of letters and numbers. Another property may be “number,” which is an ID that may only include numbers. For example, each customer may be associated with each property, including, e.g., a customer name and a customer number. Similarly, each dealer may be associated with each property, including, e.g., a dealer name and a dealer number. Similarly, each geographic region may be associated each property, including, e.g., a geographic region name and a geographic region number.

Management computer 110 may populate each of autocomplete data structures 142 based on respective properties. For example, management computer 110 may populate one of autocomplete data structures 142 with a group of strings based on a name property, including, e.g., customer names, dealer names, and geographic region names. As another example, management computer 110 may populate another of autocomplete data structures 142 with a group of strings based on a number property, including, e.g., customer numbers, dealer numbers, and geographic region numbers. Each string in the name-based autocomplete data structure may correspond to a string in the number-based autocomplete data structure, e.g., each customer name corresponding to a customer number, each dealer name corresponding to a dealer number, and each geographic region name corresponding to a geographic region number.

Technician computer 130 is a computer used by a technician such as a desktop computer, laptop computer, or smartphone. Similar to hardware platform 120, technician computer 130 includes a hardware platform (not shown) including components of a computer, such as one or more CPUs, memory such as RAM, and one or more NICs. The CPU(s) are configured to execute instructions such as executable instructions that perform one or more operations described herein, which may be stored in the memory. The NIC(s) enable technician computer 110 to communicate with other devices over a network such as the Internet.

The hardware platform of technician computer 130 supports software including a customer support application 132. Customer support application 132 is software that may be programmed to access customer support software 114 of management computer 110. Although illustrated as a dedicated application, embodiments are not limited as such. For example, a technician may alternatively access customer support software 114 using a web browser (not shown) executing on technician computer 130.

Hardware solutions 150 are physical devices or systems designed to perform various functions. Examples of hardware solutions include, e.g., printers, MFPs, scanning devices, etc. Computers 160 are, e.g., server computers supporting software solutions 162. Software solutions 162 are software applications or systems designed to perform various functions. Examples of software solutions include, e.g., enterprise resource planning systems, customer relationship management systems, content management systems, etc. For example, hardware solutions 150 and software solutions 162 may be produced by the same organization operating customer support software 114.

FIG. 2A is a block diagram of a prefix tree 200 that may be used for autocompleting names associated with solutions, according to some embodiments. A prefix tree, also known as a “trie,” is a data structure in which each node, other than a root node, may represent a single character of a string. Strings may be stored in the order of their constituent characters, beginning at the root node. Further, nodes in a prefix tree may be shared by strings when such strings include overlapping characters, which allows for efficient storage.

In the example of FIG. 2A, names such as customer names, dealer names, and geographic region names may be stored as strings and retrieved by traversing the nodes of prefix tree 200. For example, the name “TABS” may be retrieved by traversing prefix tree 200 from the root node to the nodes storing the characters, “T,” “A,” “B,” and “S.” The name “TAIS” may be retrieved by traversing prefix tree 200 from the root node to the nodes storing the characters, “T,” “A,” “I,” and “S.” The names “TABS” and “TAIS” share 2 nodes, one storing the character “T” and another storing the character “A.” The names “THOM,” “THC,” “TEAMS,” and “TEARM” may similarly be retrieved by traversing prefix tree 200.

If management computer 110 receives text related to names, customer support software 114 may traverse prefix tree 200 to determine matching IDs as autocomplete options. Customer support software 114 may traverse prefix tree 200 in an order that matches an order of the text. For example, if the text is “TH,” customer support software 114 may traverse prefix tree 200 from the root node to the node storing the character “T,” and then to the node storing the character “H” to determine that “THOM” and “THC” are matching IDs for presenting to the technician as autocomplete options.

FIG. 2B is a block diagram of a prefix tree 210 that may be used for autocompleting numbers associated with solutions, according to some embodiments. In the example of FIG. 2B, numbers such as customer numbers, dealer numbers, and geographic region numbers may be stored as strings and retrieved by traversing the nodes of prefix tree 210. For example, the number “0004” may be retrieved by traversing prefix tree 210 from the root node to the nodes storing the characters, “0,” “0,” “0,” and “4.” The number “0019” may be retrieved by traversing prefix tree 210 from the root node to the nodes storing the characters, “0,” “0,” “1,” and “9.” The numbers “0004” and “0019” share 2 nodes, each storing the number “0.” The numbers “0123,” “019,” “0256,” and “0259” may similarly be retrieved by traversing prefix tree 210.

If management computer 110 receives text related to numbers, customer support software 114 may traverse prefix tree 210 to determine matching IDs as autocomplete options. For example, if the text is “02,” customer support software 114 may traverse prefix tree 210 from the root node to the node storing the character “0,” and then to the node storing the character “2” to determine that “0256” and “0259” are matching IDs for presenting to the technician as autocomplete options. It should be noted that, in practice, a prefix tree may store many more strings than the amounts illustrated in FIGS. 2A and 2B, and such strings may be longer than those illustrated in FIGS. 2A and 2B.

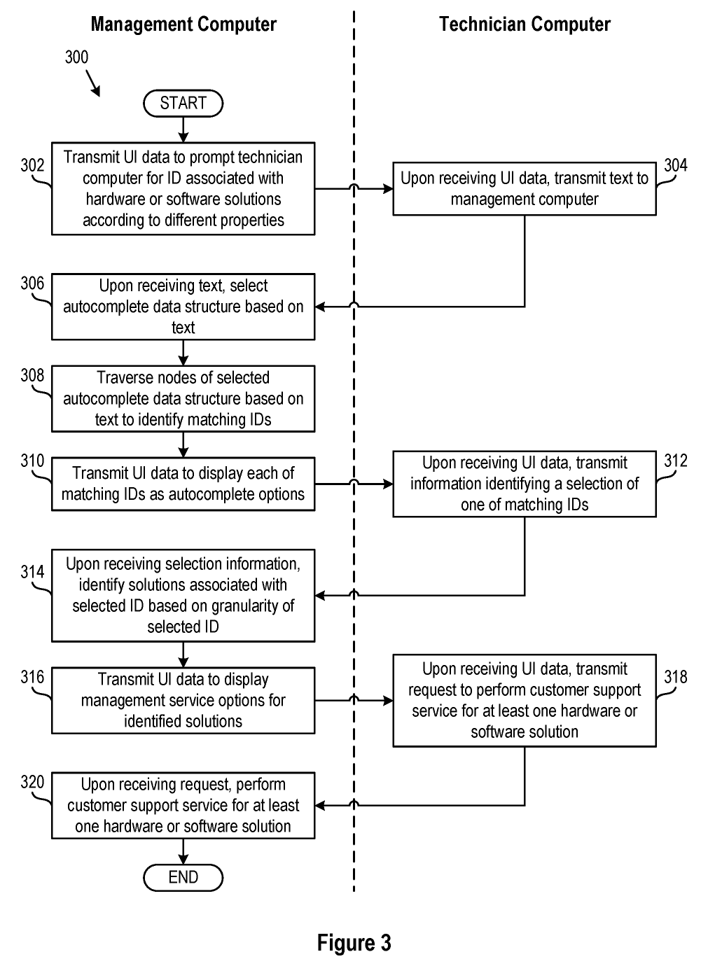

FIG. 3 is a flow diagram of a method 300 that may be performed by management computer 110 and technician computer 130 to manage customer support services for hardware solutions 150 and software solutions 162, according to some embodiments. For example, method 300 may be performed upon a technician remotely accessing customer support software 114, e.g., using customer support application 132. At step 302, management computer 110 may transmit UI data to technician computer 130. The UI data may prompt customer support application 132 for an ID associated with hardware solutions 150 or software solutions 162. Furthermore, the UI data may specify different properties, e.g., by asking the technician to begin entering ether a name or number.

At step 304, upon receiving the UI data, technician computer 130 transmits text to management computer 110. Such text may be entered by the technician by typing the text in the UI via customer support application 132. It should be noted that, according to some embodiments, the UI data discussed with respect to steps 302 and 304 may be built in to customer support application 132. According to such embodiments, step 302 may be skipped, and the technician may simply type the text upon loading customer support application 132.

At step 306, upon receiving the text from technician computer 130, customer support software 114 selects one of autocomplete data structures 142 based on the text. For example, customer support software 114 may first determine, based on the text, whether the technician is entering a name or a number. For example, if all names begin with a letter and the text begins with a letter, customer support software 114 may select a name-based autocomplete data structure such as prefix tree 200 of FIG. 2A. As another example, if the text begins with a number, customer support software 114 may select a number-based autocomplete data structure such as prefix tree 210 of FIG. 2B.

At step 308, customer support software 114 traverses nodes of the selected autocomplete data structure based on the text to identify matching IDs. For example, if the selected autocomplete data structure is a name-based autocomplete data structure, the matching IDs may include any of matching customer names, dealer names, and geographic region names. As another example, if the selected autocomplete data structure is a number-based autocomplete data structure, the matching IDs may include any of matching customer numbers, dealer numbers, and geographic region numbers. At step 310, management computer 110 transmits UI data to technician computer 130 to display each of the matching IDs as autocomplete options.

At step 312, upon receiving the UI data, technician computer 130 transmits information to management computer 110 identifying a selection of one of the matching IDs. For example, the technician may click on a matching ID via customer support application 132 or type on a keyboard to indicate such selection via customer support application 132. At step 314, upon receiving the selection information, customer support software 114 identifies solutions associated with the selected ID based on a granularity of the selected ID. For example, if the selected ID is a customer name or number, customer support software 114 may identify hardware solutions 150 or software solutions 162 associated with a particular customer.

Similarly, if the selected ID is a dealer name or number, customer support software 114 may identify solutions associated with a particular dealer. Similarly, if the selected ID is a geographic region name or number, customer support software 114 may solutions associated with customers and dealers in a particular geographic region. The selected autocomplete data structure may store, at a node corresponding to the selected ID, which solutions are associated with the selected ID. As another example, management computer 110 may store associations between IDs and solutions in a data structure separate from autocomplete data structures 142, e.g., also in database 140. Accordingly, customer support software 114 may check the selected autocomplete data structure or a separate data structure to identify associated solutions.

At step 316, management computer 110 transmits UI data to technician computer 130 to display management service options for the identified solutions. At step 318, upon receiving the UI data, technician computer 130 transmits a request to management computer 110 to perform a customer support service for at least one solution. For example, the customer support service may target one of hardware solutions 150 or software solutions 162. For example, the technician may click on a customer support service via customer support application 132 or type on a keyboard to indicate such customer support service.

At step 320, upon receiving the request, management computer 110 performs the customer support service for the at least one solution. There are many different customer support services management computer 110 may perform. For example, management computer 110 may communicate with a targeted one of hardware solutions 150 or with one of computers 160 on which a targeted one of software solutions 162 is executing, to collect health or performance information of the targeted hardware or software solution. As another example, management computer 110 may generate a service request for the targeted hardware or software solution and transmit the service request to technician computer 130.

As another example, management computer 110 may transmit bits for updating software to the targeted hardware solution, in response to which the targeted hardware solution may update software thereon. Similarly, management computer 110 may transmit bits for updating the targeted software solution to the one of computers 160 on which the targeted software solution is running, in response to which the one of computers 160 may update the targeted software solution. As another example, management computer 110 may transmit updated configurations to the targeted hardware solution, in response to which the targeted hardware solution may apply the updated configurations to software executing thereon. Similarly, management computer 110 may transmit updated configurations to the one of computers 160 on which the targeted software solution is running, in response to which the one of computers 160 may apply the updated configurations to the targeted software solution. After step 320, method 300 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

The embodiments described herein also relate to an apparatus for performing these operations. The apparatus may be specially constructed for required purposes, or the apparatus may be a general-purpose computer selectively activated or configured by a computer program stored in the computer. The embodiments described herein may also be practiced with computer system configurations including mobile computing devices, personal computers, server computers, microprocessor systems, mainframe computers, etc., and combinations thereof, which may communicate across one or more networks.

The embodiments described herein also relate to one or more computer programs or as one or more computer program modules embodied in computer-readable storage media. The term computer-readable medium refers to any data storage device that can store data, which can thereafter be input into an apparatus or computer system. Computer-readable media may be based on any existing or subsequently developed technology that embodies computer programs in a manner that enables a computer to read the programs. Examples of computer-readable media include magnetic drives, SSDs, network-attached storage (NAS) systems, RAM, read-only memory (ROM), compact disks (CDs), digital versatile disks (DVDs), and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

As used herein, the phrase “at least one of” preceding a series of items with the term “and” or “or” to separate any of the items, modifies the list as a whole, rather than each member of the list (i.e., each item). The phrase “at least one of” does not require selection of at least one of each item listed. Rather, the phrase allows a meaning that includes at least one of any one of the items, and/or at least one of any combination of the items. By way of example, the phrases “at least one of A, B, and C” and “at least one of A, B, or C” each refers to only A, only B, only C, and/or any combination of A, B, and C. In any instances in which it is intended that a selection be of “at least one of each of A, B, and C,” or alternatively, “at least one of A, at least one of B, and at least one of C,” the selection is expressly described as such.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components may be implemented as a combined component. Similarly, structures and functionalities presented as a single component may be implemented as separate components. These and other variations, additions, and improvements may fall within the scope of the appended claims.

What is claimed is:

1. A management computer including a processor and memory, wherein the processor executes instructions stored in the memory to manage customer support services for hardware and software solutions, by performing the following steps:
selecting, based on text received from a technician computer, a first autocomplete data structure from a plurality of autocomplete data structures;
traversing nodes of the first autocomplete data structure based on the text to identify a plurality of matching identifiers (IDs) that each includes the text;
transmitting user interface (UI) data to the technician computer to display each of the matching IDs as autocomplete options, and then receiving information from the technician computer identifying a selection of one of the matching IDs;
transmitting UI data to the technician computer to display management service options for hardware or software solutions associated with the selected ID, and then receiving a request from the technician computer to perform a customer support service for at least one hardware or software solution associated with the selected ID; and
performing the customer support service for the at least one hardware or software solution.

2. The management computer of claim 1, wherein the step of performing the customer support service includes:
performing at least one of: (1) communicating with a hardware solution associated with the selected ID or with a computer executing a software solution associated with the selected ID, to collect health or performance information, (2) generating a service request for the hardware solution or for the software solution and transmitting the service request to the technician computer, (3) transmitting bits for updating software to the hardware solution or to the computer executing the software solution, and (4) transmitting updated configurations to the hardware solution or to the computer executing the software solution.

3. The management computer of claim 1, wherein the first autocomplete data structure corresponds to a name property, and the steps further include:
determining, based on the text beginning with a letter, to select the first autocomplete data structure.

4. The management computer of claim 1, wherein the first autocomplete data structure corresponds to a number property, and the steps further include:
determining, based on the text beginning with a number, to select the first autocomplete data structure.

5. The management computer of claim 1, wherein the steps further include:
populating the first autocomplete data structure with a first group of strings based on a name property;
populating a second autocomplete data structure of the autocomplete data structures with a second group of strings based on a number property, each string of the second group of strings corresponding to a string of the first group of strings; and
persisting the first and second autocomplete data structures in a database of the management computer.

6. The management computer of claim 1, wherein the steps further include:
identifying the hardware or software solutions associated with the selected ID based on a granularity associated with the selected ID, the granularity being one of (1) end user of hardware or software solutions, (2) intermediary that provides hardware or software solutions to end users, and (3) geographic region.

7. The management computer of claim 1, wherein the first autocomplete data structure is a prefix tree, and the step of traversing nodes of the first autocomplete data structure includes:
starting at a root node of the prefix tree and then traversing nodes of the prefix tree in an order that matches an order of the text.

8. A method of managing customer support services for hardware and software solutions, the method comprising:
selecting, based on text received from a technician computer, a first autocomplete data structure from a plurality of autocomplete data structures;
traversing nodes of the first autocomplete data structure based on the text to identify a plurality of matching identifiers (IDs) that each includes the text;
transmitting user interface (UI) data to the technician computer to display each of the matching IDs as autocomplete options, and then receiving information from the technician computer identifying a selection of one of the matching IDs;
transmitting UI data to the technician computer to display management service options for hardware or software solutions associated with the selected ID, and then receiving a request from the technician computer to perform a customer support service for at least one hardware or software solution associated with the selected ID; and
performing the customer support service for the at least one hardware or software solution.

9. The method of claim 8, wherein performing the customer support service includes:
performing at least one of: (1) communicating with a hardware solution associated with the selected ID or with a computer executing a software solution associated with the selected ID, to collect health or performance information, (2) generating a service request for the hardware solution or for the software solution and transmitting the service request to the technician computer, (3) transmitting bits for updating software to the hardware solution or to the computer executing the software solution, and (4) transmitting updated configurations to the hardware solution or to the computer executing the software solution.

10. The method of claim 8, wherein the first autocomplete data structure corresponds to a name property, the method further comprising:
determining, based on the text beginning with a letter, to select the first autocomplete data structure.

11. The method of claim 8, wherein the first autocomplete data structure corresponds to a number property, the method further comprising:
determining, based on the text beginning with a number, to select the first autocomplete data structure.

12. The method of claim 8, further comprising:
populating the first autocomplete data structure with a first group of strings based on a name property;
populating a second autocomplete data structure of the autocomplete data structures with a second group of strings based on a number property, each string of the second group of strings corresponding to a string of the first group of strings; and
persisting the first and second autocomplete data structures in a database.

13. The method of claim 8, further comprising:
identifying the hardware or software solutions associated with the selected ID based on a granularity associated with the selected ID, wherein the granularity is one of (1) end user of hardware or software solutions, (2) intermediary that provides hardware or software solutions to end users, and (3) geographic region.

14. The method of claim 8, wherein the first autocomplete data structure is a prefix tree, and traversing nodes of the first autocomplete data structure includes:
starting at a root node of the prefix tree and then traversing nodes of the prefix tree in an order that matches an order of the text.

15. A non-transitory, computer-readable medium comprising instructions that are executable in a management computer, wherein the instructions when executed cause the management computer to carry out a method of managing customer support services for hardware and software solutions, and wherein the method comprises:
selecting, based on text received from a technician computer, a first autocomplete data structure from a plurality of autocomplete data structures;
traversing nodes of the first autocomplete data structure based on the text to identify a plurality of matching identifiers (IDs) that each includes the text;
transmitting user interface (UI) data to the technician computer to display each of the matching IDs as autocomplete options, and then receiving information from the technician computer identifying a selection of one of the matching IDs;
transmitting UI data to the technician computer to display management service options for hardware or software solutions associated with the selected ID, and then receiving a request from the technician computer to perform a customer support service for at least one hardware or software solution associated with the selected ID; and
performing the customer support service for the at least one hardware or software solution.

16. The non-transitory, computer-readable medium of claim 15, wherein performing the customer support service includes:
performing at least one of: (1) communicating with a hardware solution associated with the selected ID or with a computer executing a software solution associated with the selected ID, to collect health or performance information, (2) generating a service request for the hardware solution or for the software solution and transmitting the service request to the technician computer, (3) transmitting bits for updating software to the hardware solution or to the computer executing the software solution, and (4) transmitting updated configurations to the hardware solution or to the computer executing the software solution.

17. The non-transitory, computer-readable medium of claim 15, wherein the first autocomplete data structure corresponds to a name property, and the method further comprises:
determining, based on the text beginning with a letter, to select the first autocomplete data structure.

18. The non-transitory, computer-readable medium of claim 15, wherein the first autocomplete data structure corresponds to a number property, and the method further comprises:
determining, based on the text beginning with a number, to select the first autocomplete data structure.

19. The non-transitory, computer-readable medium of claim 15, wherein the method further comprises:
populating the first autocomplete data structure with a first group of strings based on a name property;
populating a second autocomplete data structure of the autocomplete data structures with a second group of strings based on a number property, each string of the second group of strings corresponding to a string of the first group of strings; and
persisting the first and second autocomplete data structures in a database of the management computer.

20. The non-transitory, computer-readable medium of claim 15, wherein the method further comprises:
identifying the hardware or software solutions associated with the selected ID based on a granularity associated with the selected ID, the granularity being one of (1) end user of hardware or software solutions, (2) intermediary that provides hardware or software solutions to end users, and (3) geographic region.
